(19) United States
(12) Patent Application Publication
(10) Pub. No.: US 2004/0037026 A1
(43) Pub. Date: Feb. 26, 2004

(54) Keypad and keypad system

(76) Inventor: Eligo Mori, Koshigaya (JP)

Correspondence Address: Robert H. Kelly, Scheef & Stone, L.L.P., Suite 1400, 5956 Sherry Lane, Dallas, TX, 75225, US

(21) Appl. No.: 10/463,195

(22) Filed: Jun. 17, 2003

(30) Foreign Application Priority Data
Jun. 18, 2002 (JP) JP2002-177557

(51) Int. Cl. G06F 1/16

(52) U.S. Cl. 361/680; 361/683

(57) ABSTRACT

A wireless keypad equipped with no power source (rechargeable battery or the like) that contributes to reducing the weight, thickness and size and a keypad system, liberating the user from the work and from the burden of cost. The keypad system includes a keypad having a plurality of input keys and one or a plurality of RF-IDs corresponding to the keys, and a host unit including RF-ID read means which is connected to the keypad in a wireless manner through the RF-IDs to read key data stored in the RF-IDs, and control means which is connected to the RF-ID read means to execute the operation inclusive of control operation upon obtaining the key data from the RF-ID read means.

### BACKGROUND OF THE INVENTION

1. Field of the Invention

This invention relates to a key device (hereinafter referred to as keypad) which is, generally, called keyboard, keypad or remote control unit, and is used being attached to, or in cooperation with, an electronic equipment such as a personal computer, a network communication equipment or a video/acoustic equipment, for inputting data to the electronic equipment, and to a system which includes such a device. More particularly, the invention relates a keypad system in which the keypad (accessory unit) and the host unit (main unit) are connected together in a wireless manner.

2. Description of the Related Art

A wireless keypad which has heretofore been used contains a power source (battery) such as cells mounted in the keypad. When the power source is depleted, therefore, the user of the device must recharge the battery or renew the power source itself. When attention is given, for example, to conventional keyboards which are keypads connected to a personal computer in a wireless manner, some of them are equipped with an on/off switch for saving the mounted power source.

However, the conventional wireless keypads have problems as described below. That is, since the keypad is mounting the power source, the user must carryout cumbersome work such as recharging the depleted power source or replacing the cells, and must bear an expenditure. With the power source being contained, further, the keypad itself becomes heavy. Besides, the user must turn the switch of the keyboard on/off on his own responsibility, and often finds it cumbersome to turn the switch.

### SUMMARY OF THE INVENTION

The keypad and the keypad system according to the invention were accomplished in view of the above problems. Namely, the invention provides a wireless connection system for connecting a host unit to a keypad which is easy to use and is compact in size without causing the keypad user to bear a cumbersome burden such as recharging the power source, exchanging the cells, or turning the switch on/off.

In order to solve the above problems and to achieve a desired object, a keypad and a keypad system according to the invention are constituted as described below.

That is, a keypad system comprising:

a keypad having a plurality of input keys and one or a plurality of RF-IDs corresponding to the keys; and

a host unit including RF-ID read means which is connected to the keypad in a wireless manner through the RF-IDs to read key data stored in the RF-IDs, and control means which is connected to the RF-ID read means to execute the operation inclusive of control operation upon obtaining the key data from the RF-ID read means.

It is desired that the keypad does not have a power source such as a storage cell, a rechargeable cell or an AC adapter. The RF-ID read means may have its own power source. Desirably, however, it is desired that the RF-ID read means is served with the drive energy from the host unit.

The keypad system may be a remote control unit for an electronic equipment. Or, the keypad system may be a keyboard for a computer. In these cases, it is desired that the RF-ID read means is so constituted as to receive the power source from the electronic equipment or the computer body.

Another aspect of the invention is concerned with a keypad comprising a plurality of input keys, key data storage means for storing key data corresponding to the keys, and energy-receiving means for receiving energy from outside the main body to drive the main body in a non-contacting manner, wherein the key data are transmitted by using the above energy. The method of receiving the drive energy from outside the main body in a non-contacting manner may be the one using a laser beam, RF waves or a magnetic field. It is desired that this keypad has no power source, either.

### BRIEF DESCRIPTION OF THE DRAWINGS

FIG. 1 is a view of a system constitution of a personal computer, and illustrates a keypad system according to an embodiment of the invention; and

FIG. 2 is a flowchart illustrating a flow of process in the keypad system according to the invention.

### DETAILED DESCRIPTION OF THE INVENTION

An embodiment of a keypad and a keypad system according to the invention will be described in detail with reference to the drawings.

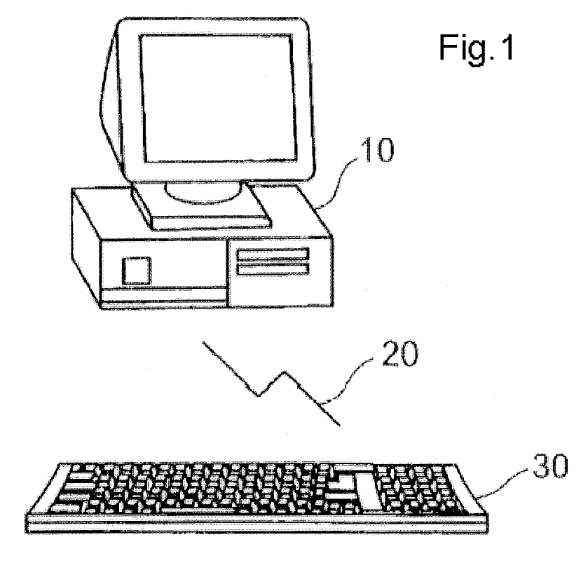

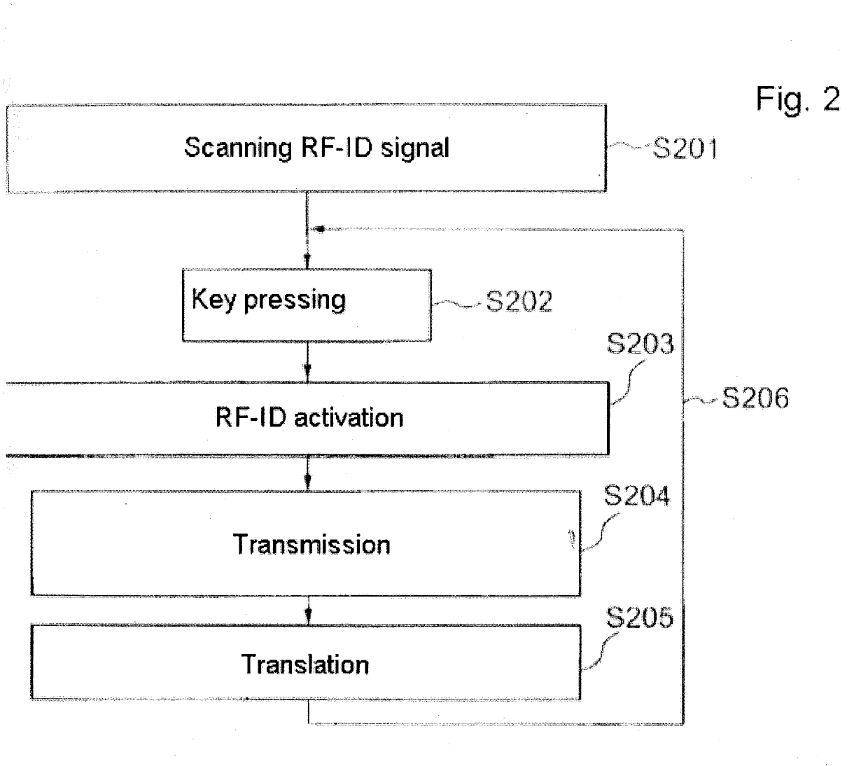

FIGS. 1 and 2 illustrate a keypad system according to an embodiment of the invention, wherein FIG. 1 is a view of a system constitution in which the keypad system of the invention is applied to a personal computer, and FIG. 2 is a flowchart illustrating the flow of process in the keypad system of the invention.

In the keypad system of the constitution shown in FIG. 1, a main unit 10 (host unit) of the personal computer and a keyboard 30 (keypad) are connected together through connection means such as wireless means, the connection means being a wireless connection means 20 based on RF-IDs.

The RF-ID used in the invention stands for a radio-frequency identification, and is a system for reading and writing data written into electronic circuits such as cards, labels and tags through electromagnetic waves or the like waves.

The main unit 10 (host unit) has RF-ID read means for recognizing RF-ID, and an RF-ID reader for executing the reading. The keyboard 30 (keypad) having a plurality of, or many, input keys on the upper surface thereof, includes RF-IDs corresponding to the individual keys. When the keys are depressed, therefore, signals specifying the keys are transmitted from the RF-IDs corresponding to the keys, and are recognized by a reader in the main unit 10.

Described below is a case of PC (personal computer) which is a representative example of the host unit connected to the keypad. In general, the PC has a PS/2 connector for connection to the keyboard. Therefore, the RF-ID reader may be connected to the PS/2 connector and may, in this case, be supplied with the electric power through the PS/2 connector. The RF-ID reader alternately repeats the RF-ID scanning or the radiation of electromagnetic waves and a mode of receiving the electromagnetic waves transmitted from the RF-IDs. The electromagnetic waves are those of a frequency in the RF band, such as the electromagnetic waves of a frequency of about 2.4 GHz. The RF-ID in the keypad converts the electromagnetic waves into drive energy, and transmits the data stored therein again by carrying it on the electromagnetic waves. The invention is provided with means for operating the RF-IDs corresponding to the keys only when the keys are depressed by providing, for example, switches for mechanically cutting part of the circuits. When the keys are thus depressed, the RF-IDs corresponding to the keys operate, and the key data stored in the RF-IDs are transmitted. The RF-ID reader receives the key data that are transmitted, and converts the received ID into a corresponding key code. In a standard PC, it is desired that the RF-ID corresponding to the depressed key that is read out, is transmitted to the PC body through the reader connected to the PS/2 connector. In this case, no change or modification is required for the computer itself.

FIG. 2 is a flowchart illustrating the flow of a process in the keypad system according to the invention. Steps in FIG. 2 will now be concretely described.

Step S201:

When the host unit (main unit 10 of PC) is driven, the RF-ID reader performs the scanning for reading signals from the RF-IDs.

Step S202:

A desired key selected by the user is depressed among many number of keys provided on the keyboard.

Step S203:

Upon depressing the key, the corresponding RF-ID operates.

Step S204:

The RF-ID receives electromagnetic waves from the reader, converts the electromagnetic waves into drive energy, and transmits the stored data.

Step S205:

The RF-ID reader converts the tag ID into a corresponding key code.

After the end of step S205, the operation flows as indicated by an arrow (→) 206 to a position between step S201 and S202 to further repetitively execute step S202→step S203→step S204→step S205→step S202.

In other words, at S201, WHEN THE HOST UNIT STARTS UP, THE RF-ID READER EFFECTS THE SCANNING FOR READING SIGNALS FROM THE RF-IDs. At S202, KEY IS DEPRESSED S203, AS THE KEY IS DEPRESSED, A CORRESPONDING RF-ID OPERATES At S204, THE RF-ID RECEIVES ELECTROMAGNETIC WAVES FROM THE READER, CONVERTS THE WAVES INTO DRIVE ENERGY, AND TRANSMITS THE STORED DATA And at S205, THE RF-ID READER CONVERTS A TAG ID INTO A CORRESPONDING KEY CODE

The conventional wireless keyboard contained the power source on the inside arousing various problems. In order to radically improve these problems according to this embodiment, however, the data that a particular key is depressed is transmitted by using RF-ID. Roughly speaking, means for executing the system by using RF-IDs according to the invention requires an RF-ID reader on the host unit side, and requires RF-IDs corresponding to the keys on the keypad side. The RF-ID has means for storing and preserving the data and means for transmitting/receiving data signals.

The RF-ID requires a dedicated reader. However, the keypad requires no power source since it is driven upon receiving electromagnetic waves radiated from the reader. In the wireless keyboard according to this embodiment, therefore, no power source is required on the keyboard side.

However, the RF-ID is capable of transmitting only those data stored in the memory unit on the keypad side. Therefore, the wireless keyboard according to this embodiment requires a specific RF-ID for each of the keys. Most simply, the RF-ID may be provided for each of the keys. However, the number of the RF-IDs can be decreased if each key is corresponded to a plurality of RF-IDs, such as operating two RF-IDs upon the depression of one key.

In this embodiment, the reader provided on the host unit side must have a power source. The reader is a device for transmitting such a data that a key is depressed to the host unit (computer body). In connecting the reader to the host unit, the power source of the reader may be independent of others. When they are to be connected together by using the PS/2 connector or the USB connector, the power source can be established through these connectors, and no new power source is required.

The invention realizes a wireless keypad (inclusive of keyboard, key device such as remote control unit) which operates without at all requiring an internal (or externally connected) power source as a result of improving the conventional wireless keypad which must be furnished with a power source.

Since the battery no longer needs to be mounted or the AC source no longer needs to be supplied from an external unit, the invention provides a keypad that contributes to reducing the weight, thickness and size and a keypad system, liberating the user from the work related to the power source (battery) and from the burden of cost.

1. A keypad system comprising:
a keypad having a plurality of input keys and one or a plurality of RF-IDs corresponding to the keys; and
a host unit including RF-ID read means which is connected to the keypad in a wireless manner through the RF-IDs to read key data stored in the RF-IDs, and control means which is connected to the RF-ID read means to execute the operation inclusive of control operation upon obtaining the key data from the RF-ID read means.

2. A keypad system according to claim 1, wherein the keypad is equipped with no power source.

3. A keypad system according to claim 1, wherein the RF-ID read means is served with the drive energy from the host unit.

4. A keypad system according to claim 1, wherein the keypad system is a remote control unit for an electronic equipment.

5. A keypad system according to claim 1, wherein the keypad system is a keyboard for a computer.

6. A keypad comprising a plurality of input keys, key data storage means for storing key data corresponding to the keys, and energy-receiving means for receiving energy from outside the main body to drive the main body in a non-contacting manner, wherein the key data are transmitted by using the above energy.

7. A keypad according to claim 6, wherein the keypad is equipped with no power source.
